(19) United States
(12) Patent Application Publication
(10) Pub. No.: US 2025/0172966 A1
(43) Pub. Date: May 29, 2025

(54) WRAP FOR COVERING ELECTRONIC EQUIPMENT

(71) Applicant: 1417 Development Ltd., Calgary (CA)

(72) Inventor: Jayson GARDNER, Calgary (CA)

(21) Appl. No.: 18/518,858

(22) Filed: Nov. 24, 2023

(51) Int. Cl. G06F 1/16

(52) U.S. Cl. CPC G06F 1/1633

(57) ABSTRACT

Provided are wraps configured for covering at least a selected portion of an electronic equipment. The wrap comprises a planar body, with a shape configured for covering an external surface of the selected portion of the electronic equipment. The planar body comprises a first surface configured for attaching to the external surface of the selected portion of the electronic equipment and a second surface opposite of the first surface.

### FIELD OF THE DISCLOSURE

The present disclosure relates generally to wraps for covering electronic equipment. In particular, the present disclosure relates to wraps with shapes configured for covering selected portions of the electronic equipment.

### BACKGROUND

Electronic equipment, including telecommunications and/or information technology equipment, is common and exists in everyone's life. As such, electronic equipment provided by telecommunication service providers which is kept at a customer's premises to operate their service is commonly referred to as customer premise equipment (CPE).

CPE can be any terminal, telecommunications and/or information technology equipment kept at the customer's premises instead of the service provider's premises and capable of connecting with a provider's telecommunication circuit. A CPE device can refer to hardware purchased by a subscriber, or to those provided by an operator, a carrier, or a service provider.

By way of examples, CPE refers to devices such as telephones, routers, network hardware, residential gateways, modems, WiFi equipment, and set-top boxes, that enable consumers to access the providers' telecommunication services and distribute them in a residence or enterprise with a local area network (LAN).

In many situations, CPE is provided or rented to a customer for use for a period of time during the term of service. Then, the customer returns the CPE to the provider. For example, a customer does not need to purchase an internet modem and will return the modem back to the internet service provider upon termination of the term of service. In order to save costs, the service provider can then rent or provide this used modem to the next customer instead of always sending out brand new modem to each customer. Until the CPE stops working or its model becomes out of date and non-compatible, there is always the desire to recycle its use to save costs. There may be other ESG incentives for the service provider to optimize circular economy opportunities such as CPE redeployment.

There will be wear and tear of the electronic equipment during use of the CPE. Thus, there exists the need to prevent wear and tear, to refurbish used equipment, or to change the equipment's cosmetic appearance. Replacing an external cover of the electronic equipment is one option, which is cheaper than replacing the entire equipment. However, this option is still costly and time consuming as it will often require an equipment to be sent back to a distribution center or third party repair business to change its cover.

It is thus an object of the present disclosure to provide wraps for covering an electronic equipment, such as CPE and provide a cost effective and convenient option for preventing wear and tear, refurbishing, or changing the equipment's cosmetic appearance.

### SUMMARY

The present disclosure relates to wraps for covering electronic equipment.

According to one aspect of this disclosure, there is provided a wrap configured for covering at least a selected portion of an electronic equipment. The wrap comprises a planar body with a shape configured for covering an external surface of the selected portion of the electronic equipment. The planar body comprises a first surface configured for attaching to the external surface of the selected portion of the electronic equipment and a second surface opposite of the first surface.

In some embodiments of the present disclosure, the electronic equipment is a component of customer premise equipment.

In some embodiments of the present disclosure, the customer premise equipment is one of the following: a component of a networking hardware, a component of a gateway, a component of a WiFi equipment, a modem, a router, or a set-top box.

In some embodiments of the present disclosure, the wrap is a cover, a label, a sleeve, or a case.

In some embodiments of the present disclosure, the planar body is made of vinyl.

In some embodiments of the present disclosure, the first surface is configured for releasably attaching to the external surface of the selected portion of the electronic equipment.

In some embodiments of the present disclosure, the first surface is capable of adhering to the external surface of the selected portion of the electronic equipment via an adhesive.

In some embodiments of the present disclosure, the planar body comprises at least two portions for separately covering at least an end wall portion of the external surface of the electronic equipment and at least a sidewall portion of the external surface of the electronic equipment.

In some embodiments of the present disclosure, the end wall portion is a top portion or a bottom portion of the electronic equipment.

### BRIEF DESCRIPTION OF THE DRAWINGS

These and other features of the present disclosure will become more apparent in the following detailed description in which reference is made to the appended drawings. The appended drawings illustrate one or more embodiments of the present disclosure by way of example only and are not to be construed as limiting the scope of the present disclosure.

FIG. 1 is a plan view of a wrap with a modular design, for covering sidewalls of a WiFi gateway modem (XB6 model), according to one embodiment of this disclosure;

FIG. 2 is a plan view of a wrap with a monolithic design, for covering sidewalls of a WiFi gateway modem (XB6 model), according to another embodiment of this disclosure;

FIG. 3 is a plan view of a wrap with a modular design, for covering sidewalls of a WiFi gateway modem (XB7 model), according to one embodiment of this disclosure;

FIG. 4 is a plan view of a wrap with a monolithic design, for covering sidewalls of a WiFi gateway modem (XB7 model), according to one embodiment of this disclosure;

FIG. 5 is a plan view of a wrap for covering a top portion of a set-top box (Xi6 model), according to one embodiment of this disclosure;

FIG. 6 is a plan view of a wrap for covering a top portion of a set-top box (XiOne model), according to one embodiment of this disclosure;

FIG. 7 is a plan view of a wrap for covering a WiFi getaway modem (XB8 model), according to one embodiment of this disclosure; and

FIG. 8 is a plan view of a wrap for covering a top portion of a WiFi getaway modem (XB6 model).

### DETAILED DESCRIPTION

Unless defined otherwise, all technical and scientific terms used herein have the meanings that would be commonly understood by one of skill in the art in the context of the present description. Although any methods and materials similar or equivalent to those described herein can also be used in the practice or testing of the present disclosure, the preferred methods and materials are now described. All publications mentioned herein are incorporated herein by reference to disclose and describe the methods and/or materials in connection with which the publications are cited.

As used herein, the singular forms “a”, “an”, and “the” include plural references unless the context clearly dictates otherwise. For example, reference to “an agent” includes one or more agents and reference to “a subject” or “the subject” includes one or more subjects.

As used herein, the term “wraps” refers to anything that is configured for covering a surface of a component of electronic equipment. For example, a wrap can be a cover, a label, a sleeve, or a case. A wrap can be made of any suitable material, such as vinyl, plastic, or rubber. In particular, in the present disclosure, the wrap comprises a planar body, with a shape configured for covering an external surface of a selected portion of a component of electronic equipment.

As used herein, the term “planar body” refers to the body of the wrap and comprises a first surface configured for attaching to the external surface of the selected portion of the electronic equipment and a second surface opposite of the first surface. In some embodiments, the first surface is configured for releasably attaching to the external surface of the selected portion of the electronic equipment. In some other embodiments of the present disclosure, the first surface is capable of adhering to the external surface of the selected portion of the electronic equipment via an adhesive.

As used herein, the term “electronic equipment” refers to any equipment that involves the controlled conduction of electrons such as a computer, a television, a telephone, and any terminal, telecommunications and/or information technology equipment. For example, in some embodiments, an electronic equipment is also a customer premise equipment.

As used herein, the term “customer premise equipment” refers to a specific type of electronic equipment and includes any terminal, telecommunications and/or information technology equipment kept at the customer's premises instead of the service provider's premises and capable of connecting with a provider's telecommunication circuit. A CPE can refer to a device purchased by a subscriber, or to those provided by an operator, a carrier, or a service provider. By way of examples, CPE can refers to devices such as telephones, routers, networking hardware, residential gateways, modems, WiFi equipment, and set-top boxes, that enable consumers to access the providers' telecommunication services and distribute them in a residence or enterprise with a local area network (LAN).

The present disclosure relates to wraps for covering one or more desired surfaces of a component of electronic equipment.

In some embodiments of the present disclosure, the wrap disclosed herein comprises a planar body, with a shape configured for covering an external surface of a selected portion of the electronic equipment. The planar body comprises a first surface configured for attaching to the external surface of the selected portion of the electronic equipment and a second surface opposite of the first surface.

Advantageously, as the wraps disclosed in the present disclosure matches the shape of a selected portion of the electronic equipment, they can be conveniently put on the external surface of the electronic equipment. For example, for a CPE that is provided or rented to a customer for his or her use for a period of time during the term of service and then gets returned to the provider, the wraps can provide a non-expensive way of refurbishing the used CPE. In particular, they may also be used to cosmetically refurbish the electronic equipment to provide any desired or customized colors, patterns, and/or images. For a used but still working CPE, this saves the costs and expense to replace a new cover or to replace a portion of the CPE. Furthermore, the wraps may be also put on a CPE to protect it by preventing scratches.

Furthermore, compared to cleaning a CPE manually with cleaners, which may not be able to thoroughly clean all surfaces of a CPE, it is more economical and convenient for applying one or more wraps to a CPE or a portion of the CPE. In general, the labour involved in wrapping a CPE is about the same regardless of the material of the wrap and is cheaper compared to the cleaning option. Furthermore, in the event that the CPE sustained physical, cosmetic damage, the wrap embodiments of the present disclosure may provide a manner of enhancing the cosmetic appearance of such cosmetically damaged CPE.

Furthermore, the vinyl material is thin, and with a customizable colour matching, this may allow the wrapped device to look like the original device or to take on a different desired appearance. Rubber is another material that can be used for wraps.

Furthermore, although each CPE is specific and unique, the same type of CPE often has a range of standardized dimensions allowing mass production. For example, there are many types and different models of WiFi modem that are currently available on the market. While each model has its unique design, a modem generally has industry standardized dimensions. For example, set top boxes are about 5×5×1 inches and gateways or modems are about 12×6×6 inches.

As replacing an external cover of an electronic equipment or a portion of it can be expensive, pre-made wraps that fit the shape and dimensions of a portion of a specific electronic equipment may provide a cost efficient and convenient way for refurbishing used electronic equipment or to cosmetically change its appearance.

Below are examples of wraps that are suitable for refurbishing electronic equipment that meets the dimensions below and otherwise. For example, the following is a non-exhaustive list of electronic equipment models that can be refurbished by the embodiments of the present disclosure: Adtran DM1000, Arris CM9200/TM9202, Arris TB3442A/TG3442SP/TG6441/TG6442, Arris DG9450 TG9452 (11.1″×2.95″×8.07″), CBN CD8000, CBN CH8568, Hitron CODA-45 series (4582,4589), Hitron CODA-4680, Motorola MB 8600, Sercomm DM1000, Sercomm DG4244, Technicolor TC4300-AM, Technicolor CGA4234DGW, XB6 (Arris TG3482G, Technicolor CGM4140COM), XB7 (Arris TG4482, Technicolor CGM 4331COM), XB8 (Technicolor CGM 4981COM), Xi6 (all models Arris and Technicolor), and XiOne (all models Sercomm+).

### Example 1—Modular Modem Wrap

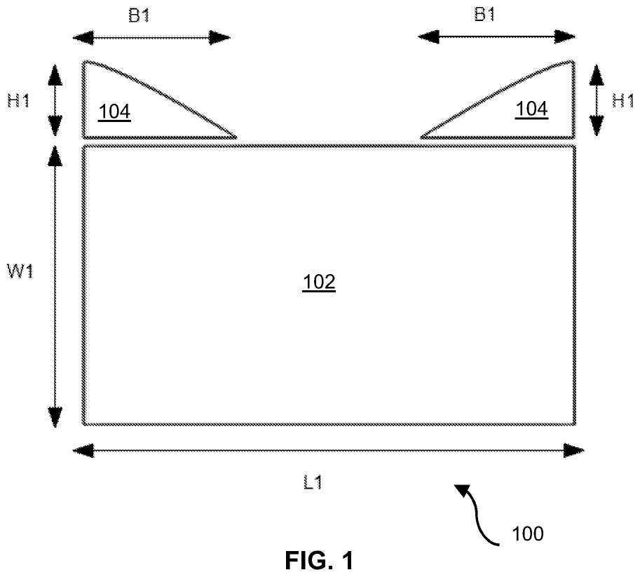

FIG. 1 is a plan view of a wrap 100 for covering side walls of a WiFi gateway modem (XB6 model), according to one embodiment of this disclosure. The wrap 100 comprises a planar body (also identified with reference numeral 100) with a modular design. The planar body comprises three portions including a bottom portion 102 and two top portions 104. The bottom portion 102 has a length L1 of 11.625 inches and a width W1 of 6.5 inches. The two top potions 104 are triangle shaped and each has a base B1 of 3.625 inches and height H1 of 1.78 inches. The shapes and dimensions of the portions 102 and 104 are configured to cover and fit over external surfaces of the sidewalls of the XB6 model modem.

Furthermore, portions 102 and 104 each has a first surface for attaching to the external surfaces of the modem and a second surface opposite of the first surface.

### Example 2—Monolithic Modem Wrap

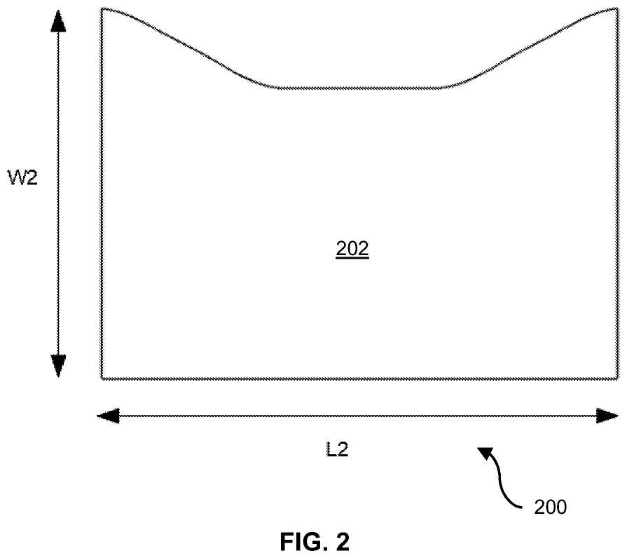

FIG. 2 is a plan view of a wrap 200 for covering sidewalls of a WiFi gateway modem (XB6 model), according to another embodiment of this disclosure. Different from wrap 100, wrap 200 has a planar body with a monolithic design. The planar body only has one portion 202 with a length L2 of 11.625 inches and a width W2 of 8.25 inches. The shape and dimensions of the portion 202 is configured to cover and fit over external surfaces of the sidewalls of the XB6 model modem.

### Example 3—Modular Modem Wrap

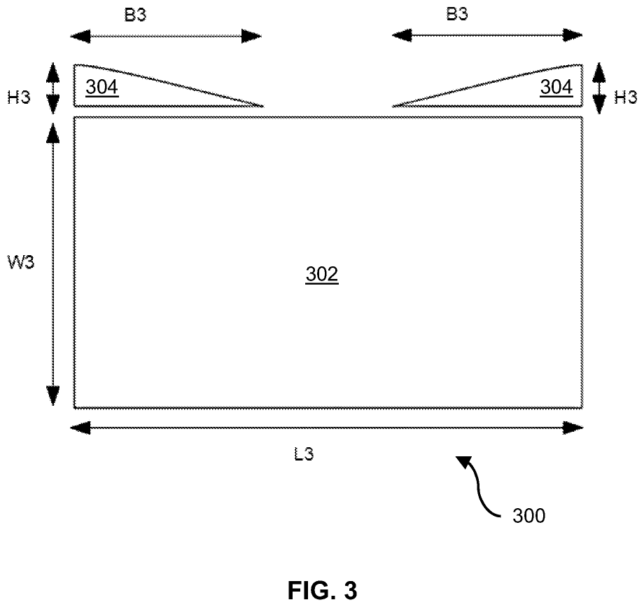

FIG. 3 is a plan view of a wrap 300 for covering sidewalls of a WiFi gateway modem (XB7 model), according to one embodiment of this disclosure. Similar to wrap 100, wrap 300 also comprises a planar body with a modular design. The planar body has a bottom portion 302 and two top portions 304. The bottom portion 302 has a length L3 of 12.125 inches and a width W3 of 6.875 inches. The two top potions 304 are triangle shaped and each has a base B3 of 4.375 inches and a height H3 of 1 inch. The shapes and dimensions of the portions 302 and 304 are configured to cover and fit over external surfaces of the sidewalls of the XB7 model modem.

### Example 4—Modem Wrap

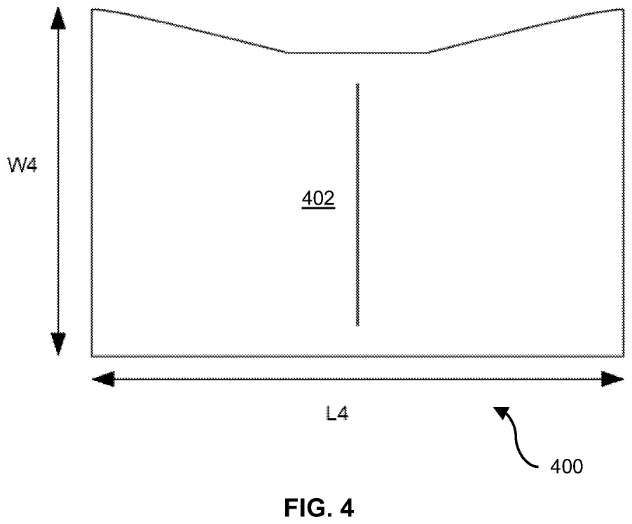

FIG. 4 is a plan view of a wrap 400 for covering sidewalls of a WiFi gateway modem (XB7 model), according to one embodiment of this disclosure. Similar to wrap 200, the wrap 400 has a planar body with a monolithic design. The planar body only has one portion 402 with a length L4 of 12.125 inches and a width W4 of 7.875 inches. The shape and dimensions of the portion 402 is configured to cover and fit over external surfaces of the sidewalls of the XB7 model modem.

### Example 5—Set-Top Box Wrap

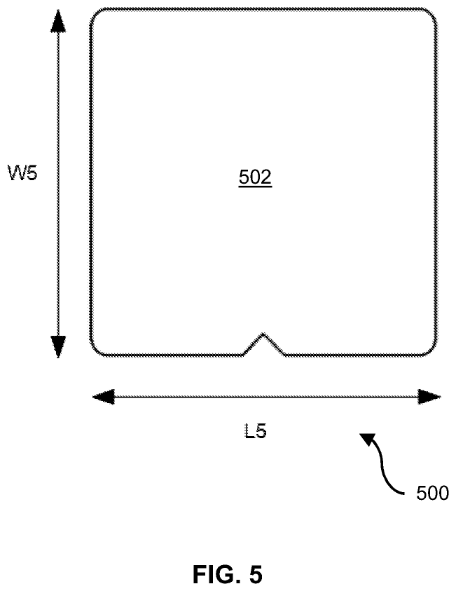

FIG. 5 is a plan view of a wrap 500 for covering a top portion of a set-top box (Xi6 model), according to one embodiment of this disclosure. The planar body of wrap 500 has one portion 502 with a length L5 of 5 inches and a width W5 of 5 inches. The shape and dimensions of the portion 502 is configured to cover and fit over external surface of the top portion of the Xi6 model set-top box.

### Example 6—Set-Top Box Wrap

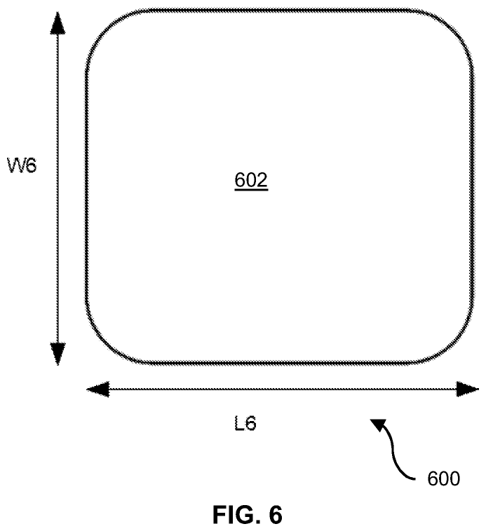

FIG. 6 is a plan view of a wrap 600 for covering a top portion of a set-top box (XiOne model), according to one embodiment of this disclosure. Similar to wrap 500, the planar body of wrap 600 also has one portion 602 with a length L6 of 3.9375 inches and a width W6 of 3.5625 inches. The shape and dimension of the portion 602 is configured to cover and fit over external surface of the top portion of the XiOne model set-top box.

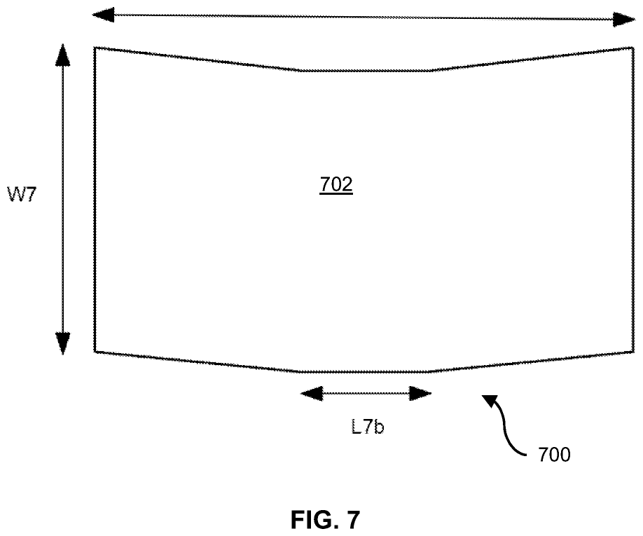

FIG. 7 is a plan view of a wrap for covering a WiFi getaway modem (XB8 model), according to one embodiment of this disclosure. The wrap 700 has a planar body with a monolithic design. The planar body only has one portion 702 with a length L7a of 13.0625inches, including a portion L7b of 3.0625 inches, and a width W7 of 7.25 inches. The shape and dimensions of the portion 702 is configured to cover and fit over external surfaces of the sidewalls of the XB8 model modem.

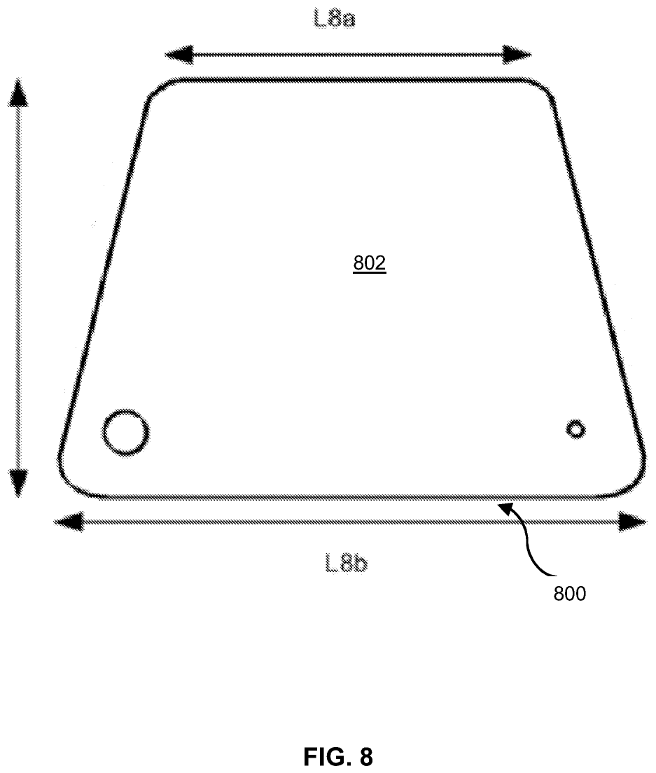

FIG. 8 is a plan view of a wrap for covering a top portion of a WiFi getaway modem (XB6 model). The wrap 800 has a planar body with a monolithic design. The planar body only has one portion 802 with a length L8b of 4.5 inches, including a portion L8a of 2.875 inches, and a width W8 of 3.125 inches. The shape and dimensions of the portion 802 is configured to cover and fit over external surfaces of the top of the XB6 model modem.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

Many obvious variations of the embodiments set out herein will suggest themselves to those skilled in the art in light of the present disclosure. Such obvious variations are within the full intended scope of the appended claims.

1. A wrap configured for covering at least a selected portion of a component of electronic equipment, the wrap comprising:
a planar body, with a shape configured for covering an external surface of the selected portion of the electronic equipment;
wherein the planar body comprises:
a first surface configured for attaching to the external surface of the selected portion of the electronic equipment; and
a second surface opposite of the first surface.

2. The wrap of claim 1, wherein the component of electronic equipment is a customer premise equipment.

3. The wrap of claim 2, wherein the customer premise equipment is one of the following: a component of a networking hardware, a component of a gateway, a component of a WiFi equipment, a modem, a router, or a set-top box.

4. The wrap of claim 1, wherein the wrap is a cover, a label, a sleeve, or a case.

5. The wrap of claim 1, wherein the planar body is made of vinyl.

6. The wrap of claim 1, wherein the first surface is configured for releasably attaching to the external surface of the selected portion of the electronic equipment.

7. The wrap of claim 1, wherein the first surface is capable of adhering to the external surface of the selected portion of the electronic equipment via an adhesive.

8. The wrap of claim 1, wherein the planar body comprises at least two portions for separately covering at least an end wall portion of the external surface of the electronic equipment and at least a sidewall portion of the external surface of the electronic equipment.

9. The wrap of claim 8, wherein the end wall portion is a top portion or a bottom portion of the electronic equipment.
